(19) United States
(12) Patent Application Publication
(10) Pub. No.: US 2023/0322267 A1
(43) Pub. Date: Oct. 12, 2023

(54) AUTONOMOUS LANE MERGING SYSTEM AND METHOD

(71) Applicant: Faraday&Future Inc., Gardena, CA (US)

(72) Inventors: Aohan Mei, San Jose, CA (US); Chen Zhang, Santa Clara, CA (US); Fan Wang, Palo Alto, CA (US)

(21) Appl. No.: 17/719,153

(22) Filed: Apr. 12, 2022

(51) Int. Cl. B60W 60/00; B60W 30/18; B60W 30/16; B60W 30/165

(52) U.S. Cl. CPC B60W 60/0027; B60W 30/18163; B60W 30/16; B60W 30/165; B60W 2552/10; B60W 2554/4049; B60W 2520/10; B60W 2520/105; B60W 2552/30; B60W 2554/4042

(57) ABSTRACT

A computer-implemented method of performing an autonomous lane merging of a vehicle. The method includes: identifying one or more objects in a plurality of lanes in the vicinity of the vehicle; identifying one or more gaps among the one or more objects; determining a mode of the vehicle; determining a terminal state of a planned trajectory of the vehicle based on the identified objects, gaps, and the mode of the vehicle; performing a sanity check based on the terminal state of the planned trajectory; generating the planned trajectory of the vehicle if the sanity check passes; providing the planned trajectory to a controller of the vehicle to autonomously move the vehicle according to the planned trajectory.

### FIELD

This relates generally to an autonomous driver assistance system of a vehicle, and specifically relates to an adaptive longitudinal cruise control and lane change assistance features of an autonomous driver assistance system.

### BACKGROUND

With Autonomous Driver Assistance System (ADAS) and Autonomous Vehicle becoming more popular, a lot of companies started to incorporate ADAS into their products (e.g., vehicles). Highway ADAS (HWA) is one of the most dominant features in ADAS, as it is deployed in a structured environment with less uncertainty and randomity.

### SUMMARY

For HWA, there are two key components: (1) Adaptive Longitudinal Cruise Control (ALCC) and (2) Lane Change Assistance (LCA). ALCC can be decomposed into two scenarios: velocity keeping and car following. LCA can also be decomposed into two scenarios: lane changing and on-ramp-off-ramp (OROR). Embodiments of the present disclosure provide the following improvements over existing systems. The embodiments increase the planning safety level by increasing the planning precision and behavior planner's rationale. The embodiments can include an adaptive dynamic function to minimize tracking errors. The embodiments can also include a feasibility-oriented sanity check that can guarantee the planned trajectory is always within a user-defined planning horizon, thereby preventing planning failure. Finally, instead of doing a massive sampling, the embodiments can narrow down the sampling space of each dimension into a narrow range through reasonable numerical deduction, which can in turn lower the total computational cost of the ADAS.

### BRIEF DESCRIPTION OF THE DRAWINGS

FIG. 1 is a block diagram illustrating the exemplary components or modules of the HWA, according to an embodiment of the disclosure.

FIG. 2 is a diagram illustrating an exemplary scenario, in which an ego vehicle with the HWA of FIG. 1 is operating in an autonomous mode, according to an embodiment of the disclosure.

FIG. 3 is a flow chart illustrating the exemplary steps in the operation of the mode manager of the HWA of FIG. 1, according to an embodiment of this disclosure.

FIG. 4 illustrates an exemplary system block diagram of vehicle control system, according to embodiments of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

In the embodiments of the disclosure, a motion planner of an HWA is designed to generate a trajectory from time T1 to T2 with initial state and end state constraints, as well as with comfortability considerations. Jerk, the changing rate of acceleration, usually serves as a key indicator of the comfortability of a planned trajectory. To build the motion planner, we form the key philosophy of our methodology into a convex optimization problem:

$${min}_{x} {\int }_{T 1}^{T 2} {x}^{…} ( t ) dt \\ states equality constraints$$

Quintic Polynomial Introduction

While numerically solving an optimization problem may consume too much computational resource, embodiments of the disclosed HWA utilize a closed form solution provided by a quintic (fifth order) polynomial. Given planning time horizon, initial state, end state, the quintic polynomial parameters can be computed via solving a 6×6 matrix. By setting each planning time horizon starts from 0, the matrix size can further be reduced into 3×3.

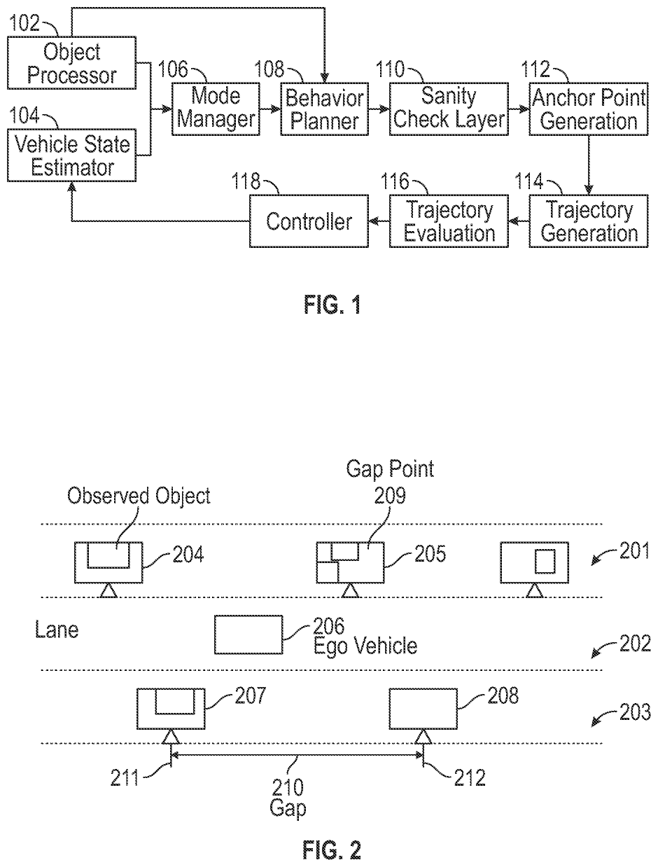

FIG. 1 is a block diagram illustrating the exemplary modules of a motion planner 100, according to an embodiment of the disclosure. In this embodiment, the motion planner 100 includes an object processor 102, a vehicle estimator 104, a mode manager 106, a behavior planner 108, a sanity check layer 110, an anchor point generator 112, a trajectory generator 114, a trajectory evaluator 116, and a controller 118. Each of the modules and its operations will be discussed in detail in the paragraphs below. The modules of FIG. 1 can be implemented in hardware, software, and/or a combination thereof.

The object processor 102 is designed to deal with complicated scenarios in which multiple observed objects exist. FIG. 2 illustrates an exemplary multi-lane 201, 202, 203 roadway having multiple objects (e.g., vehicles) 204, 205, 206, 207, 208 traveling in one or more lanes. One of the vehicles can be the ego vehicle 206, i.e., the vehicle that is fitted with the disclosed HWA system, that can perceive the environment including other objects (e.g., vehicles) 204, 205, 207, 208.

In one embodiment, the object processor 102 can identify each lane by a lane ID and a lateral displacement (d) from the ego vehicle 206's current lane center. The object processor 102 can also receive information about the observed surrounding objects from a sensor fusion module (not shown in FIG. 1). The information about each observed surrounding object can include, but not limited to, the object's object ID (obj_id), center referenced lane info (csp), longitudinal position (s), longitudinal velocity (s_d), longitudinal acceleration (s_dd), lateral position (d), lateral velocity (d_d), lateral acceleration (d_dd) in the object's Frenet path, lane ID of the lane that the object is in, and its location within ego vehicle's body frame (x, y). The ego vehicle's body frame is a coordinate system with the origin point located at the ego vehicle's center, with the x-axis pointing in the forward direction and y-axis pointing in towards the left of the ego vehicle. The object processor 102 can predict the states of the observed objects 204, 205, 207, 208 at a given time and calculate the observed objects' positions within ego vehicle 206's body frame.

In addition, the object processor 102 can identify a gap point 209 (i.e., a boundary of a gap) by the longitudinal position (s) of the gap point and longitudinal speed (s_d) of the gap point 209 in the Frenet frame. The object processor 102 can then identify a gap 210 between two observed objects 207, 208 by the left and right boundaries (GapPoint_1, Gap_Point2) 211, 212 of the gap 210 and the longitudinal speed (s_d) of the gap 210 in Frenet frame.

The object processor 102 can further include a customized buffer range for the boundary gaps, a list of objects from other modules such as the sensor fusion module, and grouped list of objects (grouped by, for example, lane ID/vector of observed objects) and gaps (grouped by, for example, lane ID/vector of sorted gaps). The sensor fusion module can fuse the data from a number of sensors (e.g., camera, lidar, radar) of the vehicle and provide data about the nearby objects including, for example, their identifications, sizes, distances from the ego vehicle, and velocities. According to one embodiment, the object processor 102 can first sort the objects 204, 205, 206, 207, 208 into different groups based on their respective lane ID. Then, the object processor 102 can sort different groups of objects based on their respective longitudinal distances. The object processor 102 can also predict each object's longitudinal and lateral states for a given time. Based on the grouped list of objects, the object processor 102 can calculate the gaps (e.g., gap 210) in each lane and form the grouped list of gaps.

Referring back to FIG. 1, the vehicle state estimator is configured to provide an estimated state of the ego vehicle including information such as velocity, lateral and longitudinal velocity, acceleration/deceleration rate, and user (e.g., driver) input.

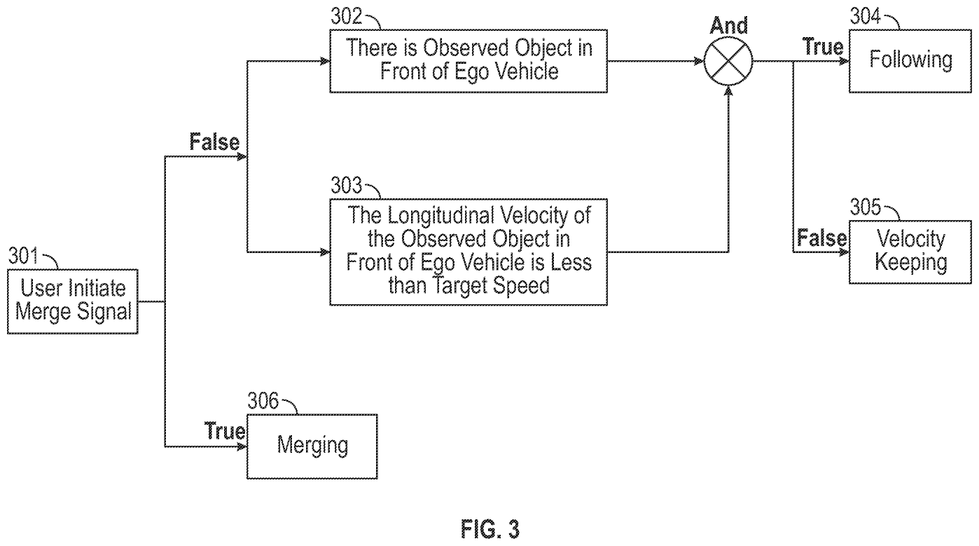

The object processor 102 and the vehicle state estimator are both in data communication with the mode manager 106. An exemplary operation of the mode manager 106, according to one embodiment of the disclosure, is illustrated in the flow chart of FIG. 3. First, the mode manager 106 determines if the user initiates a turning command signal (step 301). If the user does initiate the turning command signal, the mode manager 106 selects the merging mode (step 306), in which the ego vehicle will merge into a different lane in response to the turning command signal. If the user does not initiate the turning command signal, the mode manager 106 determines if there is an object (e.g., front vehicle) in front of the ego vehicle (step 302) and if the front vehicle's speed is less than or equal to a user defined target speed (step 303). If both of these conditions are met, the mode manager 106 switches to the following mode (step 304), in which the ego vehicle continue to follow the object (e.g., front vehicle) at a safe distance. This can require the ego vehicle to decrease its speed based on the front speed of front vehicle. If either of the conditions of steps 302 and 303 is not met, the mode manager 106 switches to the velocity keeping mode (step 305), in which the ego vehicle will maintain its velocity.

Both the object processor 102 and the mode manager 106 can be in communication with the behavior planner module 108. According to an embodiment of the disclosure, after receiving the data from the object processor 102 and the mode manager 106, the behavior planner 108 can output the terminal states of the planned trajectory that can be later used to compute the parameters of the quintic/quartic polynomial.

When the mode manager 106 selects the velocity keeping mode, the anchor point generation module 110 sets up anchor points associated to each lane for sampling and sets the terminal lateral velocity and acceleration to zero. Since velocity keeping (tracking) is not subject to position constraints, the target speed is set based on user's input.

When the mode manager 106 selects the car-following mode, the anchor point generation module 110 sets up anchor points associated with each lane for sampling and sets the terminal lateral velocity and acceleration to zero. In this mode, the following behavior is subject to position constraints. Hence, the terminal states are set as target position and target velocity, where target state is set as a buffer distance from the followed object (e.g., front vehicle) and target velocity is set as the followed object's velocity.

When the mode manager 106 selects the merging mode (i.e., lane-changing mode), the behavior planner 108 sets the lateral trajectory into two segments: during time [0, t_{merge}] the ego vehicle will continue driving in its original lane, where t_{merge} is the starting point of time of the merging (lane changing) action. During time [t_{merge}, Tₛₐₘₚₗₑ], the vehicle will attempt to merge into the target lane. If t_{merge}≤0, the ego vehicle can directly initiate merging into the target lane. With the information of gaps received from the object processor 102, the behavior planner 108 can iterate the process for each gap and uniformly sample various points in the gap as the target position. The behavior planner 108 can set the gap's speed as the ego vehicle's final speed. Once the target position and final speed are set, the behavior planner 108 can use the car-following logic described above to complete the longitudinal movement of the ego vehicle.

Referring again to FIG. 1, the behavior module 108 is in communication with the sanity check layer 110, which provides feasibility-oriented rationale. In the velocity keeping mode, the sanity check layer 110 employs a constant acceleration model, in which maximum acceleration and sampling time is included. If the discrepancy between the current speed and user defined target speed is too large. That is, for example, even with the constant maximum acceleration model the vehicle cannot arrive the target speed within the maximum sampling time, the sanity check layer 110 can adjust the target acceleration to a reachable value. In one embodiment, to accelerate tracking (convergence) speed without disturbing the comfortability of the planned trajectory, the sanity check layer 110 can use the regulation formula below about the planned initial acceleration.

αᵢₙᵢₜ=ρ·αₘₐₓ·(1−e^{-(v}^{_{target}}^{-v}^{_{curr}}⁾)

In the velocity keeping mode, no lateral sanity check is required.

In the car-following mode, the sanity check layer 110 calculates the distance from the current position to the target position (Δs) and the difference in the current velocity and the target velocity (Δv). It should be noted that using only Δs as tracking indicator may not be sufficient for a decent tracking convergence time. In one embodiment, the sanity check layer 110 can use a method of dynamically buffer the position difference as represented in the formula below.

Δs′=(1+Pₛ)Δs

sᵥᵢᵣₜᵤₐₗ=s_{curr}+Δs′

This essentially reflects an elastic “tracking force” during the car-following process, which could decrease the time at which the ego vehicle reaches its ideal tracking location.

In the car-following mode, no lateral check is required.

In the “merging” mode, there is no sanity check required in the lateral direction during time [0, t_{merge}]. During time [t_{merge}, Tₛₐₘₚₗₑ] (when the vehicle is merging into the target lane), the same sanity check described above in the car-following mode can be applied. In the longitudinal direction, again, the same sanity check performed during the car-following mode can be used after the terminal states are determined by the behavior planner 108.

After the sanity checks are completed, the anchor point generation module 112 can narrow down the sampling space as follows. In the velocity-keeping mode, the anchor point generation module 112 determines the sampling anchor point Tₛₐₘₚₗₑ in time horizon using the formula:

Tₛₐₘₚₗₑ=|v_{target}−v_{curr}|/αₘₐₓ

Then, the anchor point generation module 112 adjusts Tₛₐₘₚₗₑ to make sure [Tₛₐₘₚₗₑ−ΔTₛₐₘₚₗₑ+Δt] is within in [Tₘᵢₙ, Tₘₐₓ].

In the car-following mode, a constant acceleration model is adopted where ego vehicle is assumed to be driving with a constant acceleration during tracking process. The anchor point generation module 112 can calculate the estimated tracking time using the formula:

Tₛₐₘₚₗₑ=2·Δs′/(v_{curr}+v_{curr})

The Δs′ can be adjusted to ensure that Tₛₐₘₚₗₑ is within [Tₘᵢₙ, Tₘₐₓ]. Finally, Tₛₐₘₚₗₑ is adjusted to ensure that [Tₛₐₘₚₗₑ−Δt, Tₛₐₘₚₗₑ+Δt] is within [Tₘᵢₙ, Tₘₐₓ].

In the merging mode, after the sanity check is performed by the sanity check layer 110, the same procedure as in the car-following mode is followed based on each terminal state, with respect to longitudinal travel. With respect to lateral travel, between [0, t_{merge}], the anchor point is always locked on the original lane with zero target velocity and acceleration. Between the same procedure from the car-following mode can be followed.

After anchor point generation, trajectory generation and trajectory evaluation are performed. First, the trajectory generation module 114 can generate the trajectory of the ego vehicle. In the velocity-keeping mode, without position constraints, the trajectory generation module 114 can use quartic (4^{th} order) polynomial to generate the trajectory based on the given initial state and target state. In the car-following mode, with position constraint, the trajectory generation module 114 can use quintic (5^{th} order) polynomial to generate the trajectory based on the given initial state and target state. In the merging mode, the trajectory can be generated in the same way as in the car-following mode, with respect to both the lateral and longitudinal components of the trajectory.

The trajectory evaluation module 116 can provide trajectory validation. In one embodiment, trajectory validation can be performed in the following order: (a) speed validation, (b) acceleration validation, (c) curvature validation, and (d) collision check validation. In particular, speed validation verifies whether the trajectory under check violates a upper speed limit. Acceleration validation can ensure that the trajectory under check does not contain way points that has aggressive acceleration command for passenger comfort purpose. Curvature validation checks the curvature along the planned trajectory to make sure that it is smooth enough without drastic turns. Collision check ensures that the planned trajectory is collision free with regard to the surrounding objects. The above processing order can bear significant benefits for runtime performance because it can rule out unnecessary collision checks on invalid trajectories.

Human-like cost function design can be incorporated in trajectory evaluation. That is, a schematic for selecting the best trajectory from sample trajectories can be employed, which would best satisfy occupants' comfort and safe driving standards. For example, the selected trajectory needs to be collision free first, and then in avoidance of drastic acceleration, frequent velocity changes, etc. Cost function components can include, for example, lateral acceleration, longitudinal acceleration, lateral jerk, longitudinal jerk, max lateral acceleration, max longitudinal acceleration, target longitudinal velocity error, target lateral velocity error, longitudinal position error, lateral position error, and time cost.

In one embodiment, to evaluate each component with less bias and reduce the burden of tuning weights, each component can be normalized to constraint their value between 0 and 1.

The output of the trajectory evaluation module 116 can be fed into the controller 118, which controls the behavior (e.g., actual trajectory) of the ego vehicle.

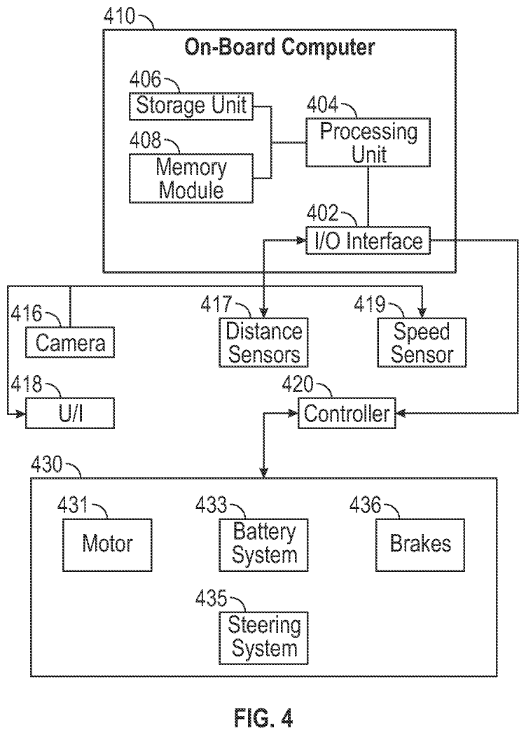

FIG. 4 illustrates an exemplary system block diagram of a vehicle control system 400 of the ego vehicle, according to examples of the disclosure. System 400 can be incorporated into a vehicle of any body style, such as but not limited to, a sports car, a coupe, a sedan, a pick-up truck, a station wagon, a sports utility vehicle (SUV), a minivan, or a conversion van. The vehicle may be an electric vehicle, a fuel cell vehicle, a hybrid vehicle, or any other types of vehicles that are fitted with regenerative braking.

Vehicle control system 400 can include one or more cameras 106 capable of capturing image data (e.g., video data) of the vehicle's surroundings. In one embodiment, the one or more cameras 106 can be front facing and capable of detecting objects such as other vehicles in front of the vehicle. Additionally or alternatively, vehicle control system 400 can also include one or more distance sensors 407 (e.g., radar, ultrasonic, and LIDAR) capable of detecting various characteristics of the vehicle's surroundings. Additionally, vehicle control system 400 can include a speed sensor 409 for determining the speed of the vehicle. The camera(s) 406, distance sensor(s) 407, and speed sensor 409 can be part of the ADAS or HWA system of the ego vehicle.

Additionally, vehicle control system 400 can include one or more user interfaces (UIs) 408 configured to receive input from the driver to control the movement of the vehicle. In one embodiment, the UIs 408 can include an accelerator pedal, a brake pedal, and steering wheel, that would allow a user (driver) to control the speed, direction, acceleration, and deceleration of the ego vehicle.

Vehicle control system 400 includes an on-board computer 410 that is operatively coupled to the cameras 416, distance sensors 417, speed sensor 419, and UIs 418. The on-board computer 410 is capable of receiving the image data from the cameras and/or outputs from the sensors 417, 419. The on-board computer 410 can also receive outputs from the UIs 418.

In accordance with one embodiment of the disclosure, the on-board computer 410 can be configured to operate the HWA 100 in response to the data/outputs from the camera(s) 416, sensor(s) 417, speed sensor 419, and UIs 418. Additionally, the on-board computer 410 is also capable of setting the vehicle in different operation modes. The different operation modes can include a normal driving mode, in which the vehicle is largely operated manually by the driver, and one of more different levels of autonomous driving modes, in which, the vehicle can provide various driving assistances to the driver including some of the features described in the embodiments of this disclosure.

In some examples, the on-board computer 410 may include, among other modules (not illustrated in FIG. 1), a I/O interface 402, a physical processing unit 404, a storage unit 406, and a memory module 408. The on-board computer 410 may be specialized to perform the ALCC and LCA functions in the embodiments described above.

I/O interface 402 may be configured for two-way communication between on-board computer 410 and various components of vehicle control system 400, such as camera(s) 416, distance sensor(s) 417, UIs 418, speed sensor 419, as well as a controller 420. I/O interface 402 may send and receive the data between each of the devices via communication cables, wireless networks, or other communication mediums.

Processing unit 404 may be configured to receive signals and process the signals to determine a plurality of conditions of the operation of the vehicle, for example, through controller 420. For example, processing unit 404 can receive image/video data from camera(s) 416 and/or sensor data from distance sensor(s) 417. The processing unit 404 can determine based on the image/video and sensor data whether there is another object (e.g., vehicle) ahead by analyzing the image/video and sensor data. In some embodiments, the processing unit 404 can determine a distance to other objects. Processing unit 404 can also receive user input (e.g., merge command signal) from UIs 418. Additionally, processing unit 404 can also receive the speed of the vehicle from the speed sensor 419.

Processing unit 404 may also be configured to generate and transmit command signals, via I/O interface 402 to controller 420 in order to actuate the various actuator systems 430 of the vehicle control system 400 as described below. The controller 420 can be the controller 118 of FIG. 1.

Storage unit 406 and/or memory module 408 may be configured to store one or more computer programs that may be executed by on-board computer 410 to perform functions of system. For example, storage unit 406 and/or memory module 408 may be configured to process instructions to enable the ALCC and LCA functions described herein.

Vehicle control system 400 may also include a controller 420 connected to the on-board computer 410 and capable of controlling one or more aspects of vehicle operation, such as performing ALCC and LCA operations using instructions from the onboard computer 410.

In some examples, the controller 420 is connected to one or more actuator systems 430 in the vehicle. The one or more actuator systems 430 can include, but are not limited to, a motor (or engine) 431, battery system 433, steering 435, and brakes 436. The on-board computer 410 can control, via controller 420, one or more of these actuator systems 430 during vehicle operation; for example, to control the speed and direction of the vehicle when the HWA system is engaged, using the motor 431, battery system 433, steering 435, brakes 436, and other actuator systems (not illustrated in FIG. 4).

A person skilled in the art can further understand that, various exemplary logic blocks, modules, circuits, and algorithm steps described with reference to the disclosure herein may be implemented as specialized electronic hardware, computer software, or a combination of electronic hardware and computer software. For examples, the modules may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A computer-implemented method of performing an autonomous lane merging of a vehicle, the method comprising:
identifying one or more objects in a plurality of lanes in the vicinity of the vehicle;
identifying one or more gaps among the one or more objects;
determining a mode of the vehicle;
determining a terminal state of a planned trajectory of the vehicle based on the identified objects, gaps, and the mode of the vehicle;
performing a sanity check based on the terminal state of the planned trajectory;
generating the planned trajectory of the vehicle if the sanity check passes;
providing the planned trajectory to a controller of the vehicle to autonomously move the vehicle according to the planned trajectory.

2. The computer-implemented method of claim 1, further comprising validating the planned trajectory before providing the planned trajectory to the controller.

3. The computer-implemented method of claim 2, wherein validating the planned trajectory comprises performing speed validation, acceleration validation, curvature validation, and collision check validation.

4. The computer-implemented method of claim 1, wherein identifying the one or more objects comprises calculating each object's position in the vehicle's body frame.

5. The computer-implemented method of claim 1, wherein identifying the one or more gaps comprises:
sorting the one or more objects into different groups based on a lane ID associated with each object, and
sorting the different groups based on longitudinal distance of each different group.

6. The computer-implemented method of claim 5, wherein identifying the one or more gaps further comprises:
predicting each object's longitudinal and lateral states for a given time; and
calculating the gaps in each lane; and
forming different groups of gaps.

7. The computer-implemented method of claim 1, wherein the mode of the vehicle comprises one of a velocity-keeping mode, a car-following mode, and a merging mode.

8. The computer-implemented method of claim 7, wherein determining the mode of the vehicle comprises:
determining whether a merge signal is initiated by a user of the vehicle;
if the merge signal is initiated, entering the merging mode;
if the merge signal is not initiated, determining if there is an object observed in front of the vehicle and if a longitudinal velocity of the observed object is less than a target speed;
if there is an object observed in front of the vehicle and the longitudinal velocity of the observed object is less than the target speed, entering the car-following mode;
if either there is no observed object or the longitudinal velocity of the observed object is no less than the target speed, entering the velocity-keeping mode.

9. The computer-implemented method of claim 7, wherein performing a sanity check based on the terminal state of the planned trajectory comprises:
determining that the vehicle is in the velocity-keeping mode; and
determining whether a constant maximum acceleration of the vehicle cannot reach the target speed within a maximum sampling time.

10. The computer-implemented method of claim 7, wherein performing a sanity check based on the terminal state of the planned trajectory comprises:
determining that the vehicle is in a car-following mode; and
calculating a distance from a current position of the vehicle to a target position and a difference in a current velocity of the vehicle and a target velocity.

11. The computer-implemented method of claim 7, wherein generating the planned trajectory of the vehicle comprises:
determining that the vehicle is in the vehicle-following mode; and
using quartic polynomial to generate the planned trajectory based on a given initial state and a target state.

12. The computer-implemented method of claim 7, wherein generating the planned trajectory of the vehicle comprises:
determining that the vehicle is in the car-following mode; and
using quintic polynomial to generate the planned trajectory based on a given initial state and a target state.

13. A vehicle comprising:
one or more sensors configured to detect objects in the vicinity of the vehicle;
an object processor configured to identify one or more objects in a plurality of lanes in the vicinity of the vehicle and further configured to identify one or more gaps among the one or more objects;
a mode manager configured to determine a mode of the vehicle;
a behavior planner configured to determine a terminal state of a planned trajectory of the vehicle based on the identified objects, gaps, and the mode of the vehicle;
a sanity check layer configured to perform a sanity check based on the terminal state of the planned trajectory;
a trajectory generation module configured to generate the planned trajectory of the vehicle if the sanity check passes; and
a controller of the vehicle configured to autonomously move the vehicle according to the planned trajectory.

14. The vehicle of claim 13, further comprising:
an anchor point generation module configure to set up a plurality of anchor points associated with each lane for sampling and set a terminal lateral velocity and acceleration of the vehicle to zero.

15. The vehicle of claim 14, further comprising:
a vehicle state estimator configured to estimate a state of the vehicle, the state comprising at least one of a velocity, speed, direction, acceleration rate, and decelerate rate of the vehicle.

16. The vehicle of claim 14, further comprising:
a trajectory evaluation module configured to validate the planned trajectory before providing the planned trajectory to the controller.

17. The vehicle of claim 14, wherein the controller is configured to control the operation of one or more of brakes, steering output, and speed of the vehicle via controlling an actuation system.

18. The vehicle of claim 14, wherein the one or more sensors comprise at least one of a camera, a radar, and a LIDAR.

19. The vehicle of claim 14, wherein the mode of the vehicle comprises one of a velocity-keeping mode, a car-following mode, and a merging mode.

20. A highway Autonomous Driver Assistance System (ADAS)
one or more sensors configured to detect objects in the vicinity of the vehicle;
a processor; and
a non-transitory storage configured to store instructions, which when executed by the processor, cause the processor to perform a method comprising:
identifying one or more objects in a plurality of lanes in the vicinity of the vehicle;
identifying one or more gaps among the one or more objects;
determining a mode of the vehicle;
determining a terminal state of a planned trajectory of the vehicle based on the identified objects, gaps, and the mode of the vehicle;
performing a sanity check based on the terminal state of the planned trajectory;
generating the planned trajectory of the vehicle if the sanity check passes;
providing the planned trajectory to a controller of the vehicle to autonomously move the vehicle according to the planned trajectory.
